(19) United States
(12) Patent Application Publication
(10) Pub. No.: US 2026/0074413 A1
(43) Pub. Date: Mar. 12, 2026

(54) Electronic Device with Asymmetric Dipole Antenna

(71) Applicant: Apple Inc., Cupertino, CA (US)

(72) Inventors: Ahmed Ali Abdelhaliem Nafe, Cupertino, CA (US); Tiejun Yu, Fremont, CA (US); Yiren Wang, Cupertino, CA (US); Sherry Cao, San Francisco, CA (US); Michael W. Firka, Sunnyvale, CA (US); Bowen Zhang, Santa Clara, CA (US); Tiffany X. Cheung, San Francisco, CA (US); Christopher A. Barber, Sunnyvale, CA (US); Elisabeth A. Lang, San Francisco, CA (US); Ming-Ju Tsai, Sunnyvale, CA (US); Cosan Caglayan, San Mateo, CA (US); Alden T. Rush, San Diego, CA (US); Hao Xu, Cupertino, CA (US); Carlo Di Nallo, Belmont, CA (US); Mattia Pascolini, San Francisco, CA (US); Justin Memar-Makhsous, Cupertino, CA (US); James L. Johnston, Cupertino, CA (US)

(21) Appl. No.: 18/826,950

(22) Filed: Sep. 6, 2024

(51) Int. Cl. H01Q 1/24; H01Q 1/48; H01Q 5/30; H01Q 9/04

(52) U.S. Cl. CPC H01Q 1/243; H01Q 1/48; H01Q 5/30; H01Q 9/0421; H01Q 9/0442

(57) ABSTRACT

An electronic device may be provided with conductive sidewalls and first and second antennas. A gap may divide the sidewalls into first and second segments separated from ground by a slot. The first antenna may be fed using a first feed coupled across the gap. The second antenna may be fed using a second feed coupled across the slot. The second antenna may include a return path coupled between a ground terminal of the first feed and the ground. The first antenna may include tuners coupled between the second segment and the ground. The first and second segments may form an asymmetric dipole that conveys signals for the first feed in a first band. The second segment may form an element that conveys signals for the first feed in a second band. The first segment may form an element that conveys signals for the second feed in a third band.

### FIELD

This relates generally to electronic devices, including electronic devices with wireless communications capabilities.

### BACKGROUND

Electronic devices such as portable computers and cellular telephones are often provided with wireless communications capabilities. To satisfy consumer demand for small form factor wireless devices, manufacturers are continually striving to implement wireless communications circuitry such as antenna components using compact structures. At the same time, there is a desire for wireless devices to cover a growing number of communications bands.

Because antennas have the potential to interfere with each other and with components in a wireless device, care must be taken when incorporating antennas into an electronic device. Moreover, care must be taken to ensure that the antennas and wireless circuitry in a device are able to exhibit satisfactory performance over a range of operating frequencies and with satisfactory efficiency bandwidth.

### SUMMARY

An electronic device may be provided with wireless circuitry and a housing having peripheral conductive housing structures. The wireless circuitry may include first and second antennas. A gap may divide the peripheral conductive housing structures into first and second segments. The first and second segments may be separated from a ground structure by a slot.

The first antenna may be fed using a first antenna feed coupled across the gap. The first antenna feed may include a first positive antenna feed terminal coupled to the second segment. The first antenna feed may include a first ground antenna feed terminal coupled to the first segment. The second antenna may be fed using a second antenna feed coupled across the slot. The second antenna feed may include a second positive antenna feed terminal coupled to the first segment. The second antenna feed may include a second ground antenna feed terminal coupled to the ground structure.

The first antenna may include one or more tuning components coupled between the second segment and the ground structure across the slot. The second antenna may include a return path coupled between the first ground antenna feed terminal and the ground structure across the slot. The first and second segments may exhibit an asymmetric dipole antenna resonating element mode that conveys radio-frequency signals for the first antenna feed in a first frequency band. The second segment may exhibit a first inverted-F antenna resonating element mode that conveys radio-frequency signals for the first antenna feed in at least a second frequency band. The first segment may exhibit a second inverted-F antenna resonating element mode that conveys radio-frequency signals for the second antenna feed in at least a third frequency band.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a cross-sectional side view of an electronic device having housing structures that may be used in forming antenna structures in accordance with some embodiments.

FIG. 5 is a top interior view of the lower end of an illustrative electronic device having peripheral conductive housing structures with dielectric gaps that divide the peripheral conductive housing structures into different segments for forming antenna resonating elements for at least two antennas in accordance with some embodiments.

FIG. 6 is a schematic diagram of an illustrative antenna having a dipole antenna resonating element in accordance with some embodiments.

FIG. 7 is a schematic diagram of an illustrative antenna having an inverted-F antenna resonating element in accordance with some embodiments.

FIG. 8 is a schematic diagram of illustrative antenna structures that include an asymmetric dipole antenna resonating element for a first antenna, where a dipole arm of the asymmetric dipole antenna resonating element forms an inverted-F antenna resonating element for a second antenna in accordance with some embodiments.

FIG. 9 is a top interior view of the lower end of an illustrative electronic device showing how illustrative antenna structures of the type shown in FIG. 8 may be integrated into different segments of peripheral conductive housing structures in accordance with some embodiments.

FIG. 10 is a plot of antenna performance (antenna efficiency) as a function of frequency showing how the antenna structures of FIG. 9 may improve antenna performance across one or more frequency bands in accordance with some embodiments.

### DETAILED DESCRIPTION

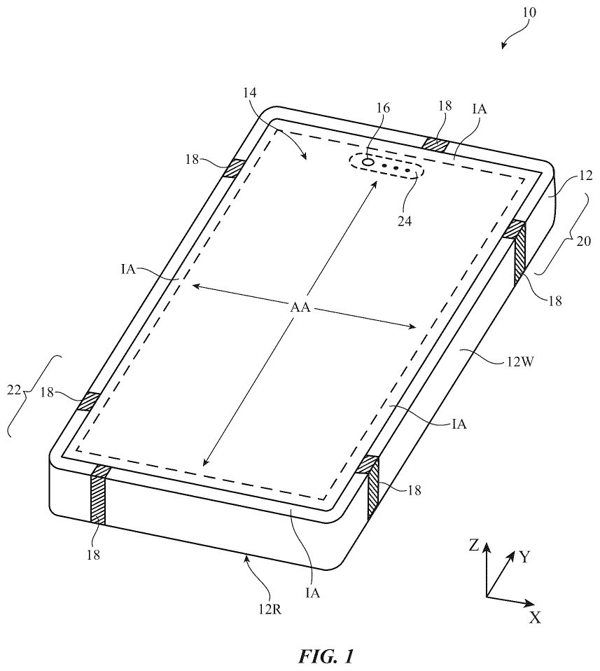

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device (e.g., virtual, augmented, or mixed reality glasses or goggles), or another wearable or miniature device, a handheld device such as a cellular telephone, a media player, or another small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color.

If desired, the inactive area IA at upper region 20 of device 10 may include an inactive region such as region 24. Region 24 may be laterally surrounded (e.g., on all sides, on four sides, etc.) by active area AA. Region 24 is sometimes also referred to herein as inactive island 24 in display 14. In other implementations, region 24 may be implemented as an inactive notch that is surrounded on three sides by active area AA and that has a fourth edge defined by peripheral conductive housing structures 12W.

Active area AA may be defined by the lateral area of a display module or panel for display 14 (e.g., a display module that includes pixel circuitry, touch sensor circuitry, etc.). Active area AA may display (emit) display light. The display light may contain images (e.g., a video stream of image frames that represent virtual objects, a graphical user interface, video file playback, etc.). The display module may have a recess or notch in upper region 20 of device 10 that is free from active display circuitry (e.g., overlapping region 24). There may, for example, be no active pixels in display 14 within region 24 that emit image for display 14. Region 24 may have a rectangular outline, a circular outline, an elliptical outline, a substantially rectangular outline with rounded edges, or any other desired shape having any desired number of curved and/or straight edges.

Device 10 may include one or more components 16 overlapping and/or aligned with region 24. Component(s) 16 may transmit signals through display 14 and/or may receive signals through display 14. Component(s) 16 may include an image sensor (e.g., a front-facing camera for capturing images through display 14), a phased antenna array (e.g., for conveying millimeter wave signals in a signal beam formed through display 14), an ambient light sensor, one or more infrared emitters (e.g., a dot projector, a flood illuminator, infrared light emitting diodes, etc.) that emit infrared light through display 14, one or more infrared sensors that receive infrared light through display 14, proximity sensors, a speaker, a microphone, and/or any other desired components.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is illustrative and non-limiting.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is illustrative and non-limiting. If desired, housing 12 may have other shapes (e.g., a square shape, cylindrical shape, spherical shape, combinations of these and/or different shapes, etc.).

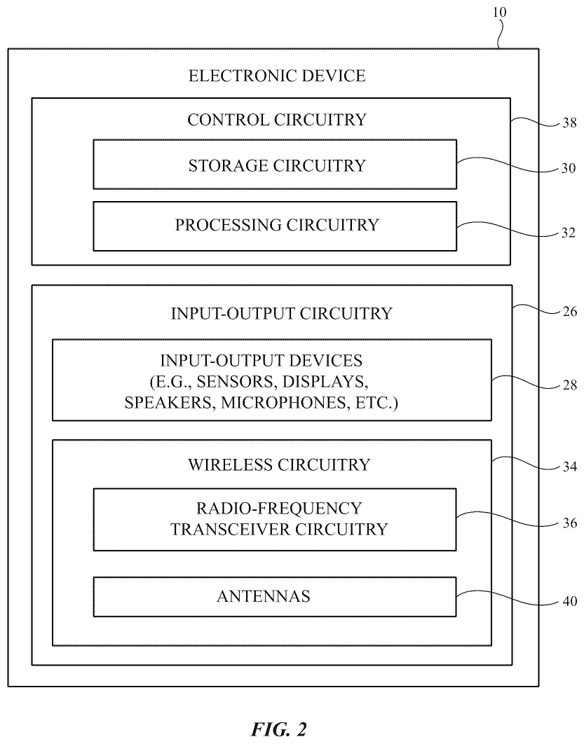

A schematic diagram of illustrative components that may be used in device 10 is shown in FIG. 2. As shown in FIG. 2, device 10 may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external equipment, control circuitry 38 may be used in implementing communications protocols. Communications protocols that may be implemented using control circuitry 38 include internet protocols, wireless local area network protocols (e.g., IEEE 802.11 protocols—sometimes referred to as Wi-Fi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals. While control circuitry 38 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband processor circuitry or other control components that form a part of wireless circuitry 34.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 34 may include radio-frequency transceiver circuitry 36 for handling transmission and/or reception of radio-frequency signals within corresponding frequency bands at radio frequencies (sometimes referred to herein as communications bands or simply as “bands”). The frequency bands handled by radio-frequency transceiver circuitry 36 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands, wireless personal area network (WPAN) frequency bands such as the 2.4 GHz Bluetooth® band or other WPAN communications bands, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, other centimeter or millimeter wave frequency bands between 10-300 GHz, or 3GPP 6G bands (e.g., sub-THz or THz bands from around 100 GHz to around 10 THz), near-field communications frequency bands (e.g., at 13.56 MHz), satellite navigation frequency bands such as the Global Positioning System (GPS) L1 band (e.g., at 1575 MHz), L2 band (e.g., at 1228 MHz), L3 band (e.g., at 1381 MHz), L4 band (e.g., at 1380 MHz), and/or L5 band (e.g., at 1176 MHz), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the family of 3GPP wireless communications standards, communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Wireless circuitry 34 may also be used to perform spatial ranging operations if desired.

The UWB communications handled by radio-frequency transceiver circuitry 36 may be based on an impulse radio signaling scheme that uses band-limited data pulses. Radio-frequency signals in the UWB frequency band may have any desired bandwidths such as bandwidths between 499 MHz and 1331 MHz, bandwidths greater than 500 MHz, etc. The presence of lower frequencies in the baseband may sometimes allow ultra-wideband signals to penetrate through objects such as walls. In an IEEE 802.15.4 system, for example, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals).

Radio-frequency transceiver circuitry 36 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). Radio-frequency transceiver circuitry 36 may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

In general, radio-frequency transceiver circuitry 36 may cover (handle) any desired frequency bands of interest. As shown in FIG. 2, wireless circuitry 34 may include antennas 40. Radio-frequency transceiver circuitry 36 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. If desired, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals within a signal beam formed in a desired beam pointing direction that may be steered/adjusted over time). Different types of antennas may be used for different bands and combinations of bands.

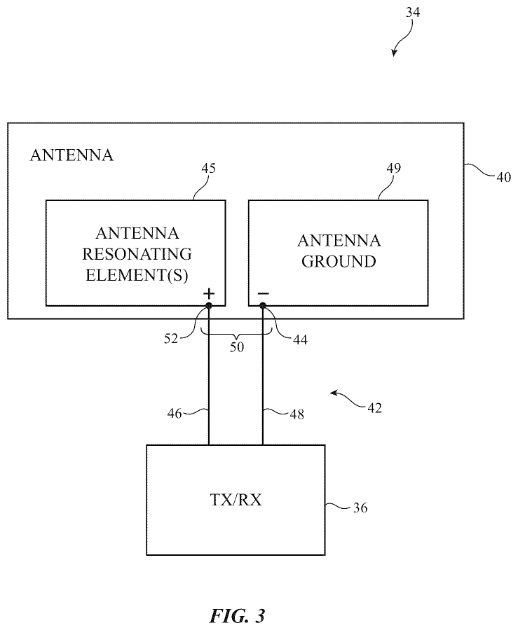

FIG. 3 is a schematic diagram showing how a given antenna 40 may be fed by radio-frequency transceiver circuitry 36. As shown in FIG. 3, antenna 40 may have a corresponding antenna feed 50. Antenna 40 may include one or more antenna resonating (radiating) elements 45 and an antenna ground 49. Antenna resonating element(s) 45 may include one or more radiating arms, slots, waveguides, dielectric resonators, patches, parasitic elements, indirect feed elements, and/or any other desired antenna radiators. Antenna feed 50 may include a positive antenna feed terminal 52 coupled to at least one antenna resonating element 45 and a ground antenna feed terminal 44 coupled to antenna ground 49. If desired, one or more conductive paths (sometimes referred to herein as ground paths, short paths, or return paths) may couple antenna resonating element(s) 45 to antenna ground 49.

In implementations where antenna resonating element 49 includes two conductors, radiators, or arms that are electrically referenced with respect to each other, such as in implementations where antenna resonating element 49 includes a dipole antenna resonating element, positive antenna feed terminal 52 may be coupled to a first of the conductors, radiators, or arms whereas ground antenna feed terminal 44 is coupled to a second of the conductors, radiators, or arms. Put differently, in these implementations, part of antenna ground 49 may form part of the antenna resonating element 45 for antenna 40. If desired, device 10 may include multiple antennas 40 where part of the antenna resonating element 45 for a first of the antennas forms part of the antenna resonating element 45 for a second of the antennas and vice versa.

Radio-frequency transceiver (TX/RX) circuitry 36 may be coupled to antenna feed 50 using a radio-frequency transmission line path 42 (sometimes referred to herein as transmission line path 42). Transmission line path 42 may include a signal conductor such as signal conductor 46 (e.g., a positive signal conductor). Transmission line path 42 may include a ground conductor such as ground conductor 48. Ground conductor 48 may be coupled to ground antenna feed terminal 44 of antenna feed 50. Signal conductor 46 may be coupled to positive antenna feed terminal 52 of antenna feed 50.

Transmission line path 42 may include one or more radio-frequency transmission lines. The radio-frequency transmission line(s) in transmission line path 42 may include stripline transmission lines (sometimes referred to herein simply as striplines), coaxial cables, coaxial probes realized by metalized vias, microstrip transmission lines, edge-coupled microstrip transmission lines, edge-coupled stripline transmission lines, waveguide structures, combinations of these, etc. Multiple types of radio-frequency transmission line may be used to form transmission line path 42. Filter circuitry, switching circuitry, impedance matching circuitry, phase shifter circuitry, amplifier circuitry, and/or other circuitry may be interposed on transmission line path 42, if desired. One or more antenna tuning components for adjusting the frequency response of antenna 40 in one or more bands may be interposed on transmission line path 42 and/or may be integrated within antenna 40 (e.g., coupled between the antenna ground and the antenna resonating element of antenna 40, coupled between different portions of the antenna resonating element of antenna 40, etc.).

If desired, one or more of the radio-frequency transmission lines in transmission line path 42 may be integrated into ceramic substrates, rigid printed circuit boards, and/or flexible printed circuits. In one suitable arrangement, the radio-frequency transmission lines may be integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All the multiple layers of the laminated structures may be batch laminated together (e.g., in a single pressing process) without adhesive (e.g., as opposed to performing multiple pressing processes to laminate multiple layers together with adhesive).

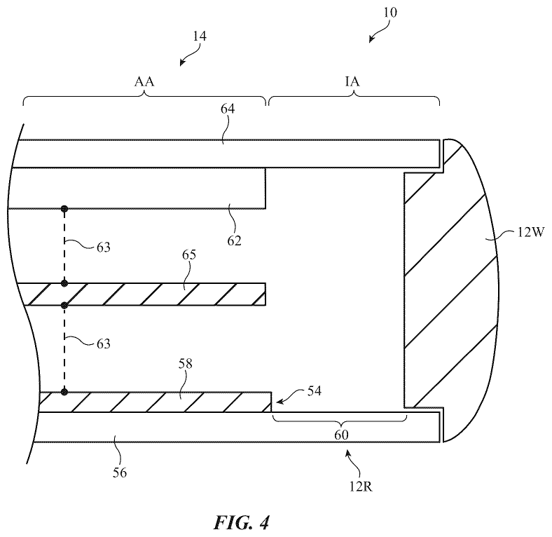

If desired, conductive electronic device structures such as conductive portions of housing 12 (FIG. 1) may be used to form at least part of one or more of the antennas 40 in device 10. FIG. 4 is a cross-sectional side view of device 10, showing illustrative conductive electronic device structures that may be used in forming one or more of the antennas 40 in device 10.

As shown in FIG. 4, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 4 (e.g., a given sidewall that runs along an edge of device 10 and that extends across the width or length of device 10).

Display 14 may have a display module such as display module 62 (sometimes referred to as a display panel). Display module 62 may include pixel circuitry, touch sensor circuitry, force sensor circuitry, and/or any other desired circuitry for forming active area AA of display 14. Display 14 may include a dielectric cover layer such as display cover layer 64 that overlaps display module 62. Display cover layer 64 may include plastic, glass, sapphire, ceramic, and/or any other desired dielectric materials. Display module 62 may emit image light and may receive sensor input (e.g., touch and/or force sensor input) through display cover layer 64. Display cover layer 64 and display 14 may be mounted to peripheral conductive housing structures 12W. The lateral area of display 14 that does not overlap display module 62 may form inactive area IA of display 14.

As shown in FIG. 4, rear housing wall 12R may be mounted to peripheral conductive housing structures 12W (e.g., opposite display 14). Rear housing wall 12R may include a conductive layer such as conductive support plate 58. Conductive support plate 58 may extend across an entirety of the width of device 10 (e.g., between the left and right edges of device 10 as shown in FIG. 1). Conductive support plate 58 may be formed from an integral portion of peripheral conductive housing structures 12W that extends across the width of device 10 or may include a separate housing structure attached, coupled, or affixed to peripheral conductive housing structures 12W.

If desired, rear housing wall 12R may include a dielectric cover layer such as dielectric cover layer 56. Dielectric cover layer 56 may include glass, plastic, sapphire, ceramic, one or more dielectric coatings, or other dielectric materials. Dielectric cover layer 56 may be layered under conductive support plate 58 (e.g., conductive support plate 58 may be coupled to an interior surface of dielectric cover layer 56). Conductive support plate 58 may be adhered to dielectric cover layer 56 or may be removable from dielectric cover layer 56. If desired, dielectric cover layer 56 may extend across an entirety of the width of device 10 and/or an entirety of the length of device 10. Dielectric cover layer 56 may overlap slot 60. If desired, dielectric cover layer 56 be provided with pigmentation and/or an opaque masking layer (e.g., an ink layer) that helps to hide the interior of device 10 from view. In another suitable arrangement, dielectric cover layer 56 may be omitted and slot 60 may be filled with a solid dielectric material.

The housing for device 10 may also include one or more additional conductive support plates interposed between display 14 and rear housing wall 12R. For example, the housing for device 10 may include a conductive support plate such as mid-chassis 65 (sometimes referred to herein as conductive support plate 65). Mid-chassis 65 may be vertically interposed between rear housing wall 12R and display 14 (e.g., conductive support plate 58 may be located at a first distance from display 14 whereas mid-chassis 65 is located at a second distance that is less than the first distance from display 14). Mid-chassis 65 may extend across an entirety of the width of device 10 (e.g., between the left and right edges of device 10 as shown in FIG. 1). Mid-chassis 65 may be formed from an integral portion of peripheral conductive housing structures 12W that extends across the width of device 10 or may include a separate housing structure attached, coupled, or affixed to peripheral conductive housing structures 12W. One or more components may be supported by mid-chassis 65 (e.g., logic boards such as a main logic board, a battery, etc.) and/or mid-chassis 65 may contribute to the mechanical strength of device 10. Mid-chassis 65 may be formed from metal (e.g., stainless steel, aluminum, etc.).

Conductive support plate 58, mid-chassis 65, and/or display module 62 may have an edge 54 that is separated from peripheral conductive housing structures 12W by dielectric-filled slot 60 (sometimes referred to herein as opening 60, gap 60, or aperture 60). Slot 60 may be filled with air, plastic, ceramic, or other dielectric materials. Conductive housing structures such as conductive support plate 58, mid-chassis 65, conductive portions of display module 62, and/or peripheral conductive housing structures 12W (e.g., the portion of peripheral conductive housing structures 12W opposite conductive support plate 58, mid-chassis 65, and display module 62 at slot 60) may be used to form antenna structures for one or more of the antennas 40 in device 10.

For example, peripheral conductive housing structures 12W may form an antenna resonating element arm (e.g., an inverted-F antenna resonating element arm) in the antenna resonating element 45 of an antenna 40 in device 10. Mid-chassis 65, conductive support plate 58, and/or display module 62 may be used to form the antenna ground 49 (FIG. 3) for one or more of the antennas 40 in device 10 and/or to form one or more edges of slot antenna resonating elements for the antennas in device 10. One or more conductive interconnect structures 63 may electrically couple mid-chassis 65 to conductive support plate 58 and/or one or more conductive interconnect structures 63 may electrically couple mid-chassis 65 to conductive structures in display module 62 (sometimes referred to herein as conductive display structures) so that each of these elements form part of the antenna ground. The conductive display structures may include a conductive frame, bracket, or support for display module 62, shielding layers in display module 62, ground traces in display module 62, etc.

Conductive interconnect structures 63 may serve to ground mid-chassis 65 to conductive support plate 58 and/or display module 62 (e.g., to ground conductive support plate 58 to the conductive display structures through mid-chassis 65). Put differently, conductive interconnect structures 63 may hold the conductive display structures, mid-chassis 65, and/or conductive support plate 58 to a common ground or reference potential (e.g., as a system ground for device 10 that is used to form part of antenna ground 49 of FIG. 3). Conductive interconnect structures 63 may therefore sometimes be referred to herein as grounding structures 63, grounding interconnect structures 63, or vertical grounding structures 63. Conductive interconnect structures 63 may include conductive traces, conductive pins, conductive springs, conductive prongs, conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to mid-chassis 65 and/or conductive support plate 58, and/or any other desired conductive interconnect structures.

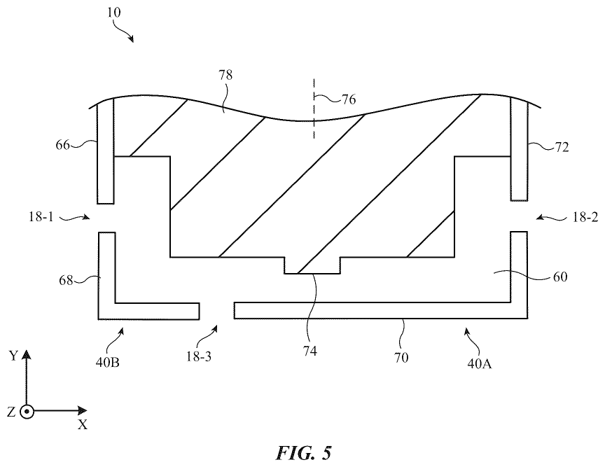

If desired, device 10 may include multiple slots 60 and peripheral conductive housing structures 12W may include multiple dielectric gaps that divide the peripheral conductive housing structures into segments (e.g., dielectric gaps 18 of FIG. 1). FIG. 5 is a top (front) interior view showing how the lower end of device 10 (e.g., within region 22 of FIG. 1) may include a slot 60 and may include multiple dielectric gaps that divide the peripheral conductive housing structures into segments for forming multiple antennas. Display 14 and other internal components have been removed from the view shown in FIG. 5 for the sake of clarity.

As shown in FIG. 5, peripheral conductive housing structures 12W may include a first conductive sidewall at the left edge of device 10, a second conductive sidewall at the top edge of device 10 (not shown in FIG. 5), a third conductive sidewall at the right edge of device 10, and a fourth conductive sidewall at the bottom edge of device 10 (e.g., in an example where device 10 has a substantially rectangular lateral shape). Peripheral conductive housing structures 12W may be segmented by dielectric-filled gaps 18 such as a first gap 18-1, a second gap 18-2, and a third gap 18-3. Gaps 18-1, 18-2, and 18-3 may be filled with plastic, ceramic, sapphire, glass, epoxy, or other dielectric materials. The dielectric material in the gaps may lie flush with peripheral conductive housing structures 12W at the exterior surface of device 10 if desired.

Gap 18-1 may divide the first conductive sidewall to separate segment 66 of peripheral conductive housing structures 12W from segment 68 of peripheral conductive housing structures 12W. Gap 18-2 may divide the third conductive sidewall to separate segment 72 from segment 70 of peripheral conductive housing structures 12W. Gap 18-3 may divide the fourth conductive sidewall to separate segment 68 from segment 70 of peripheral conductive housing structures 12W. In this example, segment 68 forms the bottom-left corner of device 10 (e.g., segment 68 may have a bend at the corner) and is formed from the first and fourth conductive sidewalls of peripheral conductive housing structures 12W (e.g., in lower region 22 of FIG. 1). Segment 70 forms the bottom-right corner of device 10 (e.g., segment 70 may have a bend at the corner) and is formed from the third and fourth conductive sidewalls of peripheral conductive housing structures 12W (e.g., in lower region 22 of FIG. 1).

Device 10 may include ground structures 78 (e.g., structures that form part of the antenna ground for one or more of the antennas in device 10). Ground structures 78 may include one or more metal layers such as a metal layer used to form a rear housing wall and/or an internal support structure for device 10 (e.g., conductive support plate 58 of FIG. 4), conductive traces on a printed circuit board, conductive portions of one or more components in device 10, conductive portions of display module 62 (FIG. 4), conductive interconnect structures that couple two or more of these structures together (e.g., conductive pins, conductive adhesive, welds, conductive tape, conductive foam, conductive springs, etc.), etc.

Ground structures 78 may extend between opposing sidewalls of peripheral conductive housing structures 12W. For example, ground structures 78 may extend from segment 66 to segment 72 of peripheral conductive housing structures 12W (e.g., across the width of device 10, parallel to the X-axis of FIG. 5). Ground structures 78 may be welded or otherwise affixed to segments 66 and 72. In another suitable arrangement, some or all of ground structures 78, segment 66, and segment 72 may be formed from a single, integral (continuous) piece of machined metal (e.g., in a unibody configuration). Ground structures 78 may include a ground extension 74 that protrudes into slot 60 and that may, if desired, bridge slot 60 and couple the ground structures to the peripheral conductive housing structures. Ground extension 74 may be formed from a data connector for device 10, as one example. Device 10 may have a longitudinal axis 76 that bisects the width of device 10 and that runs parallel to the length of device 10 (e.g., parallel to the Y-axis).

As shown in FIG. 5, slot 60 may separate ground structures 78 from segments 68 and 70 of peripheral conductive housing structures 12W (e.g., the upper edge of slot 60 may be defined by ground structures 78 whereas the lower edge of slot 60 is defined by segments 68 and 70). Slot 60 may have an elongated shape extending from a first end at gap 18-1 to an opposing second end at gap 18-2 (e.g., slot 60 may span the width of device 10). Slot 60 may be filled with air, plastic, glass, sapphire, epoxy, ceramic, or other dielectric material. Slot 60 may be continuous with gaps 18-1, 18-2, and 18-3 in peripheral conductive housing structures 12W if desired (e.g., a single piece of dielectric material may be used to fill both slot 60 and gaps 18-1, 18-2, and 18-3).

Ground structures 78, segment 66, segment 68, segment 70, and portions of slot 60 may be used in forming multiple antennas 40 in the lower region of device 10 (sometimes referred to herein as lower antennas). For example, device 10 may include at least a first antenna 40A (sometimes also referred to as ANT1) and a second antenna 40B (sometimes also referred to as ANT3) at the lower end of device 10. Antenna 40A may include an antenna resonating (radiating) element formed from at least segment 70 and may include an antenna ground formed from ground structures 78. Antenna 40B may include an antenna resonating (radiating) element formed from segment 68 and may include an antenna ground formed from ground structures 78. If desired, portions of slot 60 may also contribute one or more slot antenna resonating modes to the frequency response of one or both antennas. Antenna 40A may convey radio-frequency signals in a set of frequency bands including, but not limited to, the cellular LB, LMB, MB, and HB (e.g., from around 600 MHz to around 3000 MHz). Antenna 40B may convey radio-frequency signals in a subset of these bands and/or in other bands.

In the example of FIG. 5, segment 68 has less overall length than segment 70 (e.g., longitudinal axis 76 of device 10 runs through segment 70 but not segment 68). Given the compact form factor of device 10, segment 68 and segment 70 may each have insufficient length on its own to configure either antenna 40A or antenna 40B to exhibit a fundamental mode resonance at relatively low frequencies such as frequencies in the cellular LB. This can be further exacerbated by increasing the size of the active area AA in display 14 (FIG. 1).

In some implementations, a switch may couple segment 68 to segment 70 across gap 18-3. The switch may be turned on to extend the antenna resonating element of antenna 40A to include both segment 68 and segment 70 whenever antenna 40A needs to convey radio-frequency signals in the cellular LB. Turning the switch on may provide antenna 40A with a single antenna resonating element arm (e.g., including both segments 68 and 70) that is sufficiently long to exhibit a fundamental mode resonance that covers the cellular LB. However, the switch can introduce unnecessary loss to the antenna (e.g., limiting antenna efficiency in the cellular low band), can consume valuable real estate in device 10, can be prone to component failure or degradation over time, and can cause antenna performance to be excessively sensitive to whether or not a wired data connector has been plugged into device via a data port extending through segment 70.

To mitigate these issues, antenna 40A may be implemented as an asymmetric dipole antenna and antenna 40B may be implemented as an inverted-F antenna having an inverted-F antenna resonating element formed from part of the asymmetric dipole antenna. The asymmetric dipole antenna may include a pair of antenna arms of different lengths and collectively forming a dipole antenna resonating element in at least a first band (e.g., the cellular LB). At the same time, one of the antenna arms (e.g., the longer of the antenna arms) may form an inverted-F antenna resonating element in at least a second band (e.g., the cellular LMB, MB, and/or HB).

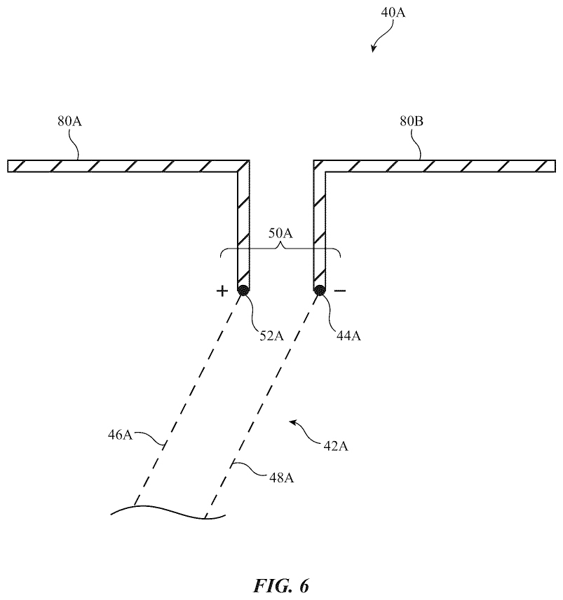

FIG. 6 is a schematic diagram of antenna 40A in implementations where antenna 40A is a symmetric dipole antenna. As shown in FIG. 6, antenna 40A may include an antenna resonating element formed from dipole arms 80 (sometimes also referred to herein as dipole antenna arms 80, dipole radiators 80, or dipole resonators 80). Dipole arms 80 may include a first dipole arm 80A and a second dipole arm 80B electrically referenced relative to dipole arm 80A. Dipole arms 80 may collectively form a dipole antenna resonating element of antenna 40A (sometimes also referred to herein as a dipole resonating element, a dipole radiating element, or a dipole). Dipole arm 80A may be formed from a first conductor whereas dipole arm 80B is formed from a second conductor separated from the first conductor by a dielectric gap.

Antenna 40A may be fed using a corresponding antenna feed 50A. Antenna feed 50A may include a positive antenna feed terminal 52A coupled to a first end of dipole arm 80A. Dipole arm 80A may extend from the first end to an opposing second end (e.g., a tip of dipole arm 80A). Antenna feed 50A may include a ground antenna feed terminal 44A coupled to a first end of dipole arm 80B. Dipole arm 80B may extend from the first end to an opposing second end (e.g., a tip of dipole arm 80B). Dipole arm 80A may have a segment extending from its tip that extends parallel to (e.g., colinear with) a segment of dipole arm 80B extending from the tip of dipole arm 80B. Dipole arms 80A and 80B may be bent (as shown in FIG. 6) or may each be entirely or substantially linear. Antenna feed 40A may be fed by a corresponding transmission line path 42A. Transmission line path 42A may include a signal conductor 46A coupled to positive antenna feed terminal 52A. Transmission line path 42A may include a ground conductor 48A coupled to ground antenna feed terminal 44A.

In the example of FIG. 6, dipole arms 80A and 80B are center-fed (e.g., antenna feed 50A feeds dipole arms 80A and 80B at a geometric center of the dipole antenna resonating element) and dipole arms 80A and 80B have the same length. This configures dipole arms 80A and 80B to collectively form an asymmetric dipole antenna resonating element for antenna 40A. The length of dipole arms 80A and 80B may be selected to configure antenna 40A to convey radio-frequency signals in one or more frequency bands. The linear distance from the tip of dipole arm 80A to the tip of dipole arm 80B may, for example, be selected to be approximately equal to one-half the effective wavelength of operation of antenna 40A (e.g., where effective wavelength is equal to the vacuum wavelength multiplied by a constant given by the dielectric materials around antenna 40A).

In implementations where antenna 40A is implemented as an asymmetric dipole antenna, dipole arm 80B may be shorter than dipole arm 80A. This also configures antenna feed 50A to feed antenna 40A at a location that is offset from the geometric center of the dipole antenna resonating element. When implemented as an asymmetric dipole antenna, the length of dipole arms 80A and 80B may collectively configure antenna 40A (e.g., the dipole antenna resonating element) to radiate in at least a first frequency band such as the cellular LB (e.g., in a dipole antenna mode of antenna 40A). At the same time, dipole arm 80A may be shorted to the antenna ground for antenna 40A by one or more tuning components and/or return paths (not illustrated in FIG. 6 for the sake of clarity), configuring dipole arm 80A to effectively form an inverted-F antenna resonating element on its own (e.g., without contribution from dipole arm 80B). The length of dipole arm 80A may configure antenna 40A (e.g., the inverted-F antenna resonating element formed from dipole arm 80A) and/or tuning components coupled to dipole arm 80A may configure antenna 40A to radiate in at least a second frequency band such as the cellular LMB, MB, and/or HB (e.g., in an inverted-F antenna mode of antenna 40A). If desired, a fundamental mode (e.g., a fundamental inverted-F antenna mode) and/or one or more harmonic modes of dipole arm 80A may contribute to the radiative response of antenna 40A. Further, dipole arm 80B may form an inverted-F antenna resonating element for an additional antenna such as antenna 40B (FIG. 5).

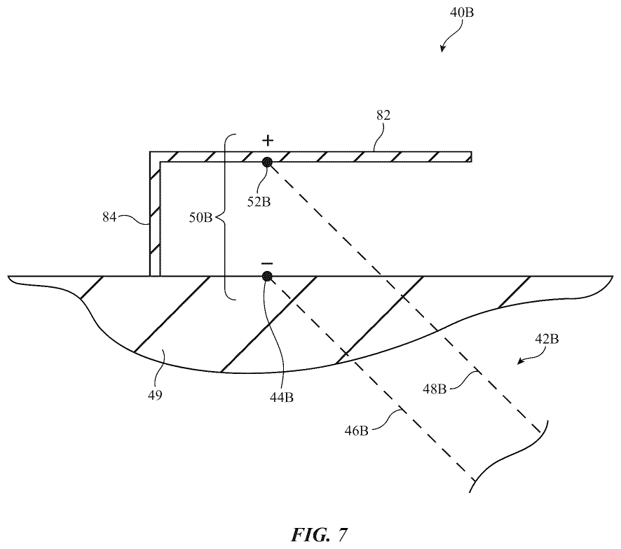

FIG. 7 is a schematic diagram of antenna 40B in implementations where antenna 40B includes an inverted-F antenna resonating element. As shown in FIG. 7, antenna 40B may include an antenna resonating element formed from antenna arm 82 and return path 84. Return path 84 may couple an end of antenna arm 82 to antenna ground 49. Antenna arm 82 may extend from return path 84 to an opposing tip. Alternatively, return path 84 may couple a point between first and second ends of antenna arm 82 to antenna ground 49.

Antenna 40 may be fed by a corresponding antenna feed 50B coupled between antenna arm 82 and antenna ground 49. Antenna feed 50B may include a positive antenna feed terminal 52B coupled to antenna arm 82. Antenna feed 50B may include a ground antenna feed terminal 44B coupled to antenna ground 49. When configured in this way, antenna arm 82 may form an inverted-F antenna resonating element arm for antenna 40B and return path 84 and antenna arm 82 may collectively form an inverted-F antenna resonating element for antenna 40B. Antenna feed 50B may be fed by a corresponding transmission line path 42B. Transmission line path 42B may include a signal conductor 46B coupled to positive antenna feed terminal 52B. Transmission line path 42B may include a ground conductor 48B coupled to ground antenna feed terminal 44B.

The length of antenna arm 82 may be selected to configure antenna 40B to convey radio-frequency signals in one or more frequency bands. The length of antenna arm 82 may, for example, be approximately equal to one-quarter the effective wavelength of operation of antenna 40B (in a fundamental mode). If desired, antenna 40B may include one or more tuning components and/or additional return paths coupled between antenna arm 82 and antenna ground 49 to tune the frequency response of antenna 40B. If desired, one or more harmonic modes of antenna arm 82 may contribute to the frequency response of antenna 40B. If desired, antenna 40B may be integrated into antenna 40A (e.g., antenna 40A and antenna 40B may be implemented using shared conductive structures).

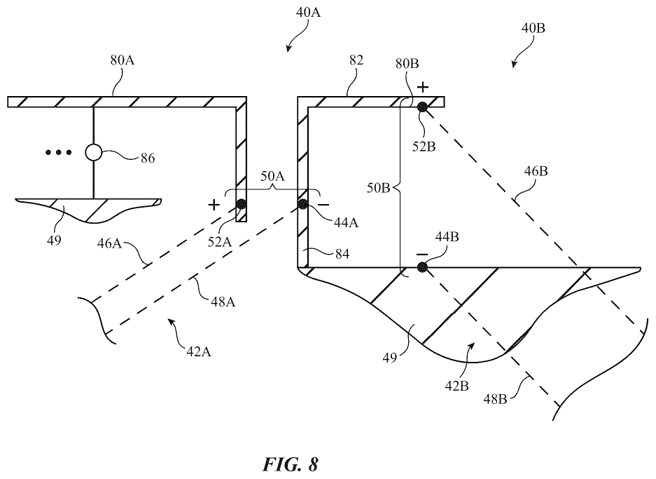

FIG. 8 is a schematic diagram showing how antenna 40A of FIG. 6 may be implemented as an asymmetric dipole antenna in at least a first frequency band (e.g., the cellular LB), dipole arm 80A of antenna 40A may form an inverted-F antenna resonating element arm in at least a second frequency band (e.g., the cellular LMB, MB, and/or HB), and dipole arm 80B of antenna 40A may form the inverted-F antenna arm of antenna 40B. The structures and components shown in FIG. 8 are sometimes referred to collectively herein as antenna structures.

As shown in FIG. 8, antenna 40A may include a first conductor that forms dipole arm 80A and may include a second conductor that forms dipole arm 80B (e.g., where the first and second conductors are separated by a gap). Antenna 40A may be implemented as an asymmetric dipole antenna where dipole arm 80B is shorter than dipole arm 80A. As such, antenna feed 50A may feed antenna 40A at a location that is offset from the geometric center of dipole arms 80A and 80B. Signal conductor 46A of transmission line path 42A may be coupled to the first conductor (dipole arm 80A) at positive antenna feed terminal 52A. Ground conductor 48A of transmission line path 42A may be coupled to the second conductor (dipole arm 80B) at ground antenna feed terminal 44A.

The second conductor (dipole arm 80B of antenna 40A) may also form the antenna arm 82 of antenna 40B (e.g., an inverted-F antenna resonating element arm for antenna 40B). The return path 84 of antenna 40B may couple ground antenna feed terminal 44A of antenna 40A to antenna ground 49. In other words, return path 84 may couple the end of antenna arm 82, the end of dipole arm 80B, and the end of the second conductor to antenna ground 49 at ground antenna feed terminal 44A of antenna feed 50A. Signal conductor 46B of transmission line path 42B may be coupled to the second conductor (dipole arm 80B or antenna arm 82) at positive antenna feed terminal 52B. Ground conductor 48B of transmission line path 42B may be coupled to antenna ground 49. In this way, the inverted-F antenna resonating element of antenna 40B may be integrated into the asymmetric dipole antenna resonating element of antenna 40A.

If desired, antenna 40A may include one or more tuning components 86 (sometimes also referred to herein as aperture tuners or tunable components) coupled between the first conductor (dipole arm 80A) and antenna ground 49. Each tuning component 86 may include one or more switches, one or more resistors, one or more capacitors, and/or one or more inductors coupled in series, in parallel, or in any desired manner between a corresponding point on dipole arm 80A and a corresponding point on antenna ground 49. The resistor(s), capacitor(s), and/or inductor(s) in each tuning component 86 may be fixed or may be adjustable.

Antenna 40B, antenna feed 50B, and transmission line path 42B may convey radio-frequency signals in the frequency band(s) of operation of antenna 40B. The length of the second conductor (dipole arm 80B or antenna arm 82) may configure antenna 40B to radiate or resonate in the frequency band(s) of operation of antenna 40B.

At the same time, antenna feed 50A, dipole arms 80A and 80B, and transmission line path 42A may convey radio-frequency signals in at least the first frequency band of operation of antenna 40A (e.g., the cellular LB). The collective length of the first and second conductors (dipole arm 80A and dipole arm 80B) may configure antenna 40A to radiate or resonate in at least the first frequency band of operation of antenna 40A (e.g., in an asymmetric dipole antenna mode).

In addition, at the same time, antenna feed 50A, dipole arm 80A, tuning component(s) 86, and transmission line path 42A may convey radio-frequency signals in at least the second frequency band of operation of antenna 40A (e.g., the cellular LMB, MB, and/or HB). The length of the first conductor (dipole arm 80A) may configure antenna 40A to radiate or resonate in at least the second frequency band of operation of antenna 40A (e.g., in an inverted-F antenna mode). Tuning component(s) 86 may adjust the response of antenna 40A to fully cover at least the second frequency band of operation of antenna 40A and/or to change the frequency response of antenna 40A over time.

The examples of FIGS. 6-8 are illustrative and non-limiting. In general, dipole arms 80A and 80B of antenna 40A and antenna arm 82 of antenna 40B may have any desired shape, any desired number of segments extending in any desired directions, multiple branches or arms, and/or any other desired number of straight and/or curved edges.

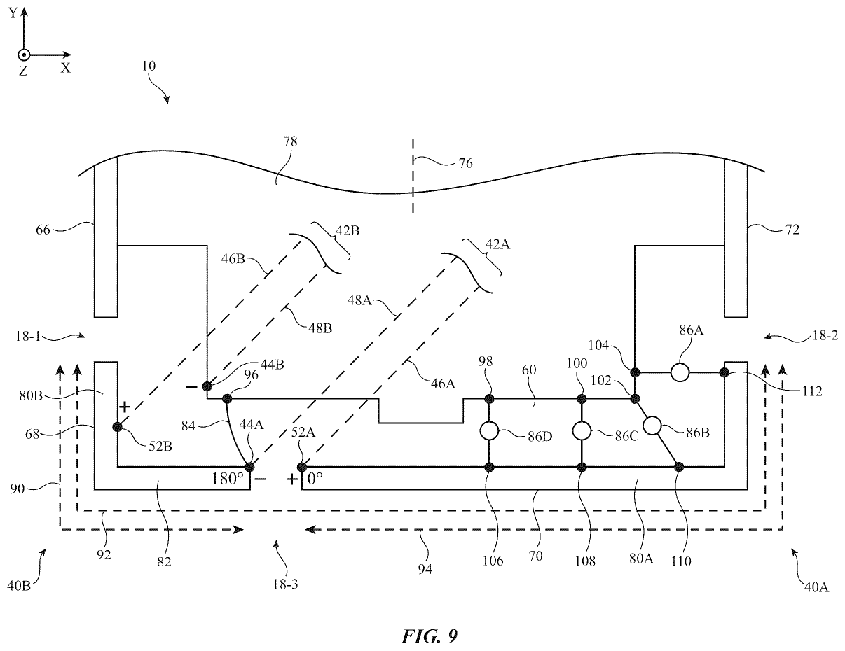

FIG. 9 is a top interior view of the lower end of device 10 showing how the first and second conductors forming antennas 40A and 40B of FIG. 8 may be integrated into the peripheral conductive housing structures of device 10. As shown in FIG. 9, segment 70 of peripheral conductive housing structures 12W may form the first conductor of FIG. 8 and thus dipole arm 80A of antenna 40A. Segment 68 of peripheral conductive housing structures 12W may form the second conductor of FIG. 8 and thus dipole arm 80B of antenna 40A and antenna arm 82 of antenna 40B. Gap 18-3 in peripheral conductive housing structures 12W may separate the first conductor from the second conductor (e.g., may separate dipole arm 80A from dipole arm 80B and antenna arm 82).

Rather than being fed across slot 60, antenna 40A may be fed across gap 18-3. Signal conductor 46A of transmission line path 42A may be coupled to segment 70 at positive antenna feed terminal 52A (e.g., at or adjacent a first side of gap 18-3). Rather than being coupled to ground structures 78, ground conductor 48A of transmission line path 42A may be coupled to segment 68 at ground antenna feed terminal 44A (e.g., at or adjacent a second side of gap 18-3).

Antenna 40A may include tuning components 86 such as tuning components 86A, 86B, 86C, and 86D coupled between different points on segment 70 and ground structures 78 across slot 60. For example, tuning component 86A may be coupled between a first point 112 on segment 70 and a first point 104 on ground structures 78. Tuning component 86B may be coupled between a second point 110 on segment 70 and a second point 102 on ground structures 78. Point 112 may be interposed on segment 70 between point 110 and gap 18-2. Point 104 may be interposed on ground structures 78 between point 102 and gap 18-2. Tuning component 86C may be coupled between a third point 108 on segment 70 and a third point 100 on ground structures 78. Point 110 may be interposed on segment 70 between point 108 and point 112. Point 102 may be interposed on ground structures 78 between point 100 and point 104. Tuning component 86D may be coupled between a fourth point 106 on segment 70 and a fourth point 98 on ground structures 78. Point 108 may be interposed on segment 70 between point 110 and point 106. Point 106 may be interposed on segment 70 between point 108 and positive antenna feed terminal 52A. Point 100 may be interposed on ground structures 78 between point 98 and point 102. Point 98 may be interposed on ground structures 78 between point 96 and point 100.

Transmission line path 42A may feed radio-frequency signals in each of the frequency bands of operation of antenna 40A. Antenna current associated with the radio-frequency signals may flow along dipole arm 80B (segment 68) and dipole arm 80A (segment 70). In at least the first frequency band covered by antenna 40A (e.g., in the cellular low band), positive antenna feed terminal 52A and thus antenna current on segment 70 may be 180 degrees out of phase with respect to ground antenna feed terminal 44A and antenna current on segment 68. Put differently, positive antenna feed terminal 52A and ground antenna feed terminal 44A may be differentially fed using differential signals/current in at least the first frequency band. This may cause antenna 40A to exhibit a resonating length 92 that extends from gap 18-1 (the tip of dipole arm 80B) to gap 18-2 (the tip of dipole arm 80A) through segments 68 and 70 in at least the first frequency band. Resonating length 92 of antenna 40A may convey the radio-frequency signals in at least the first frequency band (e.g., in a dipole antenna resonating mode of antenna 40A). Resonating length 92 may, for example, be approximately equal to half the effective wavelength corresponding to a frequency in the cellular LB. If desired, a balun may be disposed on transmission line path 42A between antenna 40A and the corresponding transceiver circuitry to convert between differential and single-ended signals in one or more bands.

At the same time, antenna current on segment 70 in at least the second frequency band covered by antenna 40A (e.g., the cellular LMB, MB, and HB) may flow along segment 70 and ground structures 78. This antenna current may convey radio-frequency signals in at least the second frequency band covered by antenna 40A. Antenna 40A may exhibit an additional resonating length 94 extending from gap 18-3 to gap 18-2 through segment 70. Resonating length 94 of antenna 40A may convey the radio-frequency signals in at least the second frequency band (e.g., in an inverted-F antenna resonating mode of antenna 40A, where segment 70 forms an inverted-F antenna resonating element arm for antenna 40A in at least the second frequency band in addition to forming dipole arm 80A for antenna 40A in at least the first frequency band). Some of this antenna current may also pass between segment 70 and ground structures 78 through one or more of tuning components 86A-86D.

If desired, tuning components 86A-86D may serve to change the impedance between segment 70 and ground structures 78 at different frequencies to tune the frequency response of antenna 40A in at least the second frequency band (e.g., via a fundamental mode and/or one or more harmonic modes of segment 70). As one example, tuning components 86A and/or 86C may tune the frequency response of segment 70 and antenna 40A in the cellular HB, tuning component 86D may tune the frequency response of segment 70 and antenna 40A in the cellular MB and/or LMB, and tuning component 86B may tune the frequency response of segment 70 and antenna 40A in the cellular LB (e.g., for the dipole antenna resonating mode of antenna 40A), the cellular LMB, and/or the cellular MB.

Antenna 40B may be fed across slot 60. Signal conductor 46B of transmission line path 42B may be coupled to segment 68 at positive antenna feed terminal 52B (e.g., a point interposed on segment 68 between ground antenna feed terminal 44A of antenna 40A and gap 18-1). Ground conductor 48B of transmission line path 42B may be coupled to ground structures 78 at ground antenna feed terminal 44B. Ground antenna feed terminal 44B may be interposed on ground structures 78 between point 96 and gap 18-1. Return path 84 of antenna 40B may couple ground antenna feed terminal 44A to point 96 on ground structures 78. If desired, one or more tuning components (not shown) may be disposed on return path 84 and/or may be coupled between one or more points on segment 68 and ground structures 78 for tuning the frequency response of antenna 40A.

Transmission line path 42B may feed radio-frequency signals in each of the frequency bands of operation of antenna 40B. Antenna current associated with the radio-frequency signals may flow along antenna arm 82 (segment 68). Antenna 40B may exhibit a resonating length 90 that extends from gap 18-1 to gap 18-3 through segment 68 that conveys the radio-frequency signals the frequency band(s) of operation of antenna 40B (e.g., in one or more inverted-F antenna resonating modes of antenna 40B).

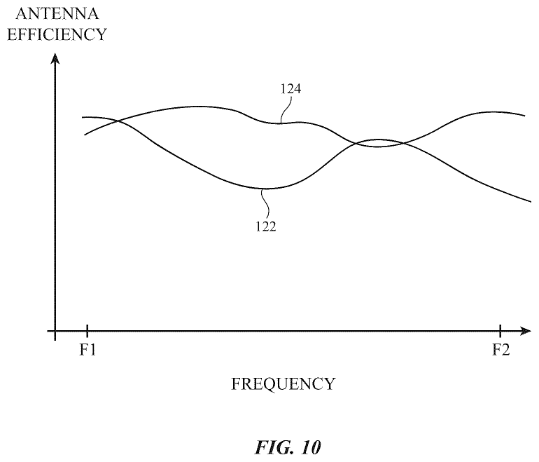

Curve 122 of FIG. 10 plots antenna performance (antenna efficiency) as a function of frequency for antennas 40A and 40B in implementations in which antenna 40A is fed across slot 60 rather than across gap 18-3 and in which a switch is coupled across gap 18-3 to configure antenna 40A to cover the cellular LB across segments 68 and 70. Curve 124 of FIG. 10 plots the antenna performance of antennas 40A and 40B as shown in FIG. 9. As shown by curves 122 and 124, implementing antenna 40A as an asymmetric dipole for covering at least the first frequency band of antenna 40A, utilizing one or more inverted-F antenna resonating element modes of segment 70 and dipole arm 80A to cover at least the second frequency band of antenna 40A, and/or utilizing one or more inverted-F antenna resonating element modes of segment 68 and dipole arm 80B to cover at least one frequency band of antenna 40B may configure antennas 40A and 40B to collectively exhibit boosted antenna efficiency across a frequency range from frequency F1 to frequency F2, particularly at relatively low and relative high frequencies in the frequency range. At the same time, antennas 40A and 40B may be relatively insensitive to whether a data connector is inserted into a data port in segment 70. The absence of a switch across gap 18-3 may save space in device 10 for other device components.

Frequency F1 may represent a lower limit of the first frequency band covered by antenna 40A (e.g., a 600 MHz edge of the cellular LB) and frequency F2 may represent an upper limit of the second frequency band covered by antenna 40A (e.g., an upper edge of the cellular LMB, MB, or HB). Curves 122 and 124 may have other shapes in practice. Frequencies F1 and F2 may be any desired frequencies.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made by those skilled in the art without departing from the scope and spirit of the described embodiments. The foregoing embodiments may be implemented individually or in any combination.

What is claimed is:

1. An electronic device comprising:
peripheral conductive housing structures that include a first segment and a second segment separated from the first segment by a dielectric-filled gap, the second segment being longer than the first segment;
a ground structure separated from the first and second segments by a slot; and
an antenna having a ground antenna feed terminal coupled to the first segment at a first side of the dielectric-filled gap and having a positive antenna feed terminal coupled to the second segment at a second side of the dielectric-filled gap.

2. The electronic device of claim 1, further comprising:
a transmission line that includes a signal conductor coupled to the positive antenna feed terminal and that includes a ground conductor coupled to the ground antenna feed terminal.

3. The electronic device of claim 2, wherein the transmission line is configured to convey a first radio-frequency signal in a first band, the ground antenna feed terminal is 180 degrees out of phase with respect to the positive antenna feed terminal in the first band, and the first and second segments are configured to form, in the first band, an asymmetric dipole antenna resonating element of the antenna.

4. The electronic device of claim 3, further comprising:
a tuning component coupled between the second segment and the ground structure across the slot.

5. The electronic device of claim 4, wherein the transmission line is configured to convey a second radio-frequency signal in a second band higher than the first band, the second segment and the tuning component being configured to form an inverted-F antenna resonating element in the second band.

6. The electronic device of claim 5, wherein the peripheral conductive housing structures further comprise:
a third segment separated from the first segment by a first additional dielectric-filled gap; and
a fourth segment separated from the second segment by a second additional dielectric-filled gap, the tuning component being coupled to the second segment at a first point that is interposed on the second segment between the positive antenna feed terminal and the second additional dielectric-filled gap.

7. The electronic device of claim 6, further comprising:
a return path that couples the ground antenna feed terminal to a second point on the ground structure.

8. The electronic device of claim 7, further comprising:
an additional antenna having an additional ground antenna feed terminal coupled to the ground structure and having an additional positive antenna feed terminal coupled to the first segment, wherein the additional positive antenna feed terminal is interposed on the first segment between the ground antenna feed terminal and the first additional dielectric-filled gap, the additional ground antenna feed terminal being interposed on the ground structure between the second point and the first additional dielectric-filled gap.

9. The electronic device of claim 8, further comprising:
a first additional tuning component coupled between a third point on the second segment and a fourth point on the ground structure, the first point being interposed on the second segment between the positive antenna feed terminal and the third point, and the second point being interposed on the ground structure between the additional ground antenna feed terminal and the fourth point;
a second additional tuning component coupled between a fifth point on the second segment and a sixth point on the ground structure, the third point being interposed on the second segment between the first point and the fifth point, and the fourth point being interposed on the ground structure between the sixth point and the second point; and
a third additional tuning component coupled between a seventh point on the second segment and an eighth point on the ground structure, the fifth point being interposed on the second segment between the third point and the seventh point, the seventh point being interposed on the second segment between the fifth point and the second additional dielectric-filled gap, the sixth point being interposed on the ground structure between the fourth point and the eighth point, and the eighth point being interposed on the ground structure between the fourth point and the second additional dielectric-filled gap.

10. The electronic device of claim 1, further comprising:
an additional antenna having an additional positive antenna feed terminal coupled to the first segment and having an additional ground antenna geed terminal coupled to the ground structure, wherein the ground antenna feed terminal is interposed on the first segment between the additional positive antenna feed terminal and the dielectric-filled gap.

11. The electronic device of claim 10, further comprising:
a conductive path that couples the ground antenna feed terminal to the ground structure across the slot.

12. An electronic device comprising:
peripheral conductive housing structures having a first segment, a second segment separated from the first segment by a first gap, a third segment separated from the second segment by a second gap, and a fourth segment separated from the third segment by a third gap;
a ground structure separated from the second and third segments by a slot;
a first antenna having a dipole antenna resonating element that includes a first arm formed from the second segment and that includes a second arm formed from the third segment; and
a second antenna having an inverted-F antenna resonating element arm formed from the second segment.

13. The electronic device of claim 12, wherein the first antenna comprises a first antenna feed coupled across the second gap, the second antenna comprising a second antenna feed coupled across the slot.

14. The electronic device of claim 13, wherein the first antenna feed comprises a first positive antenna feed terminal on the third segment and a first ground antenna feed terminal on the second structure, the second antenna feed comprises a second positive antenna feed terminal on the second segment and a second ground antenna feed terminal on ground structure, and the electronic device further comprises:
a first transmission line that includes a first signal conductor coupled to the third segment at the first positive antenna feed terminal and that includes a first ground conductor coupled to the second segment at the first ground antenna feed terminal; and
a second transmission line that includes a second signal conductor coupled to the second segment at the second positive antenna feed terminal and that includes a second ground conductor coupled to the ground structure at the second ground antenna feed terminal.

15. The electronic device of claim 14 further comprising a conductive path that couples the first ground antenna feed terminal to a point on the ground structure across the slot, wherein the second ground antenna feed terminal is interposed on the ground structure between the point and the first gap, the first ground antenna feed terminal is interposed on the second segment between the second positive antenna feed terminal and the second gap, and the second positive antenna feed terminal is interposed on the second segment between the first ground antenna feed terminal and the first gap.

16. The electronic device of claim 12, wherein the third segment is longer than the second segment.

17. The electronic device of claim 12, wherein the first antenna comprises a positive antenna feed terminal coupled to the third segment and a ground antenna feed terminal coupled to the second segment, the electronic device further comprising:
a tuning component coupled between a point on the third segment and the ground structure, the positive antenna feed terminal being interposed on the third segment between the second gap and the point, and the point being interposed on the third segment between the positive antenna feed terminal and the third gap.

18. Antenna structures comprising:
a first conductor;
a second conductor that is longer than the first conductor and that is separated from the first conductor by a gap;
a ground separated from the first and second conductors by a slot;
a first antenna feed coupled across the gap, the first antenna feed including a first positive antenna feed terminal coupled to the second conductor and including a first ground antenna feed terminal coupled to the first conductor; and
a second antenna feed coupled across the slot, the second antenna feed including a second positive antenna feed terminal coupled to the first conductor and including a second ground antenna feed terminal coupled to the ground, the first ground antenna feed terminal being interposed on the first conductor between the second positive antenna feed terminal and the gap.

19. The antenna structures of claim 18, further comprising:
a conductive path that couples the first ground antenna feed terminal to a first point on the ground structure across the slot; and
a tuning component that couples a second point on the second conductor to a third point on the ground structure across the slot, first point being interposed on the ground structure between the second ground antenna feed terminal and the third point.

20. The antenna structures of claim 19, wherein:
the first and second conductors are configured to exhibit an asymmetric dipole antenna resonating element mode that conveys first radio-frequency signals for the first antenna feed in a first frequency band;
the second conductor is configured to exhibit a first inverted-F antenna resonating element mode that conveys second radio-frequency signals for the first antenna feed in a second frequency band higher than the first frequency band; and
the first conductor is configured to exhibit a second inverted-F antenna resonating element mode that conveys third radio-frequency signals for the second antenna feed in a third frequency band higher than the first frequency band.
